(19) United States
(12) Patent Application Publication
(10) Pub. No.: US 2016/0107009 A1
(43) Pub. Date: Apr. 21, 2016

(54) FIRE SUPPRESSION PACKAGING AND METHOD OF MANUFACTURE

(71) Applicant: GelTech Solutions, Inc., Jupiter, FL (US)

(72) Inventor: Peter Cordani, Palm Beach Gardens, FL (US)

(21) Appl. No.: 14/620,925

(22) Filed: Feb. 12, 2015

Related U.S. Application Data
(60) Provisional application No. 62/064,011, filed on Oct. 15, 2014.

(51) Int. Cl. A62C 3/00; B65B 29/10; B65B 51/02; H01M 2/10; B65B 43/08

(52) U.S. Cl. CPC A62C 3/00; H01M 2/1094; B65B 43/08; B65B 51/02; B65B 29/10; H01M 2200/10

(57) ABSTRACT

A method and device for suppressing a fires within a storage receptacle. The device is a flexible receptacle containing an admixture of super absorbent polymer and water having substantially superior fire suppression and extinguishing properties at a level that is not electrically conductive. When used with lithium batteries, once a battery is placed within the receptacle should arcing or a buildup of heat occur, the receptacle will rupture and the admixture will cover the specific area. These particular properties and ratios of the admixture will enable a fire to be extinguished rapidly and not flare back up. The admixture further encapsulates noxious and toxic gases associated with a fire. A mesh or tin foil can be placed around the battery to suppress explosions.

### PRIORITY CLAIM

In accordance with 37 C.F.R. 1.76, a claim of priority is included in an Application Data Sheet filed concurrently herewith. Accordingly, the present invention claims priority to U.S. Provisional Patent Application No. 62/064,011, entitled “BATTERY STORAGE DEVICE AND METHOD OF MANUFACTURE”, filed Oct. 15, 2014. The contents of which the above referenced application is incorporated herein by reference.

### FIELD OF THE INVENTION

This invention relates to the field of fire prevention, and more particularly to a lithium battery storage device containing a hydrated amount of super absorbent polymer constructed and arranged to arrest and extinguish an electrical fire should the stored lithium battery fail.

### BACKGROUND OF THE INVENTION

As of Jan. 1, 2008, the Department of Transportation (DOT) through the Pipeline and Hazardous Materials Safety Administration (PHMSA) prohibits loose lithium batteries in checked baggage. PHMSA develops and enforces regulations for the safe, reliable, and environmentally sound operation of the nation's pipeline transportation.

Current tips for safe travel with batteries includes, but is not limited to, keeping batteries in the cabin of the airplane versus storage in checked baggage with the reasoning that the flight crew can better monitor conditions and have access to the batteries if a fire does occur; purchasing batteries from reputable sources since substandard counterfeits are more likely to malfunction and cause a fire; avoid carrying recalled or damaged batteries on the aircraft; insulate the battery terminals from contact with other batteries and metal; prohibit batteries from coming in contact with metal objects, such as coins, keys, or jewelry; and place each battery in its own protective case, plastic bag, or package.

The Federal Aviation Administration has studied fire hazards associated with both primary and lithium-ion cells and no longer allows large, palletized shipments of these batteries to be transported as cargo on passenger aircraft. The FAA research states that an explosion will not result from shorting or damaging either lithium-ion or primary lithium batteries but both types of batteries are extremely flammable. Primary lithium batteries cannot be extinguished with firefighting agents normally carried on aircraft, whereas lithium-ion batteries can be extinguished by most common extinguishing agents, including those commonly carried on board commercial aircraft.

Lithium metal batteries, including non-rechargeable lithium and primary lithium are often used with cameras and other small personal electronics. Consumer-sized batteries (up to 2 grams of lithium per battery) are typically found in non-rechargeable batteries used for personal film cameras and digital cameras, as well as the flat round lithium button cells sometimes used for calculators. Lithium ion batteries (including rechargeable lithium, lithium polymer, LIPO, secondary lithium) are allowed on a plane but within limits. Passengers may carry consumer-sized lithium ion batteries with no more than 8 grams of equivalent lithium content or 100 watt-hours of power per battery. This size covers AA, AAA, 9-volt, cell phone, PDA, camera, handheld game, standard laptop computer batteries, and camcorder batteries. Passengers can also bring up to two larger lithium ion batteries that contain between 8 and 25 grams of equivalent lithium content per battery in their carry-on luggage. Despite the fact that lithium based batteries are allowed in small quantities on airplanes, the reality is that lithium is a fire hazard and the allowance of the batteries on an airplane is based upon the assumption that the battery was manufactured properly and in good condition. Further, passengers may unknowingly exceed the guidelines. The fire issue is not limited to passenger planes as most every commercial carrier, e.g. Federal Express, UPS and the like are known to transport batteries. The potential fire hazard is a threat to the remainder of the cargo and the individuals that are handling the transportation of the batteries.

What is needed is a packaging material that can be used to prevent the potential fire threat during the storage and transportation of lithium based batteries.

### SUMMARY OF THE INVENTION

Disclosed is a packaging material, and method of manufacturing packaging material, for suppressing the potential threat of a fire arising during the storage or shipping of lithium batteries. The packaging includes an admixture of a hydrated super absorbent polymer having an amount capable of fire suppression and having fire extinguishing properties. The packaging, when formed as a receptacle, receives the battery or some instances the entire electronic device housing the battery. Should an arcing occur the packaging will release the admixture to extinguish the battery fire.

The admixture is used to saturate the immediate area around the battery further providing a benefit of cooling down the battery. The admixture viscosity inhibits flowing to adjacent areas and is non-conductive. The properties of the admixture inhibit a restart of a battery fire and when in contact with an electrical fire is capable of encapsulating noxious and toxic gases produced by the electrical fire.

Accordingly, it is an objective of the present invention to provide packaging for an admixture of non-conductive hydrated super absorbent polymer for extinguishment of battery fires.

It is another objective of the present invention to provide a receptacle for placement of lithium batteries during storage and shipping.

Still another objective of the present invention is to provide a receptacle for use in storage, shipment and recharging of electronic components such as laptops and ipads operating on lithium batteries having a barrier placement of hydrated super absorbent polymer for extinguishment of a battery fire should arcing occur.

It is a further objective of the present invention to provide a method of forming a battery storage receptacle that can be reused for storage, shipping and during battery recharging.

Still another objective of the present invention is to provide a fire extinguisher receptacle for batteries or associated electronic items that, if leaking, leaves a residual that can be removed by vacuuming when dried.

It is still yet another objective of the present invention to provide a receptacle to work with a unique admixture of super absorbent polymer and water which has viscosity that will retain a shape for a period of time. The viscosity also enables the admixture to adhere to horizontal, vertical, inclined, and on curved surfaces.

Still another objective of the invention is provide packaging that resembles bubble wrap wherein a portion, or all, bubbles are filled with a fire suppression admixture.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a pictorial view of a rectangular piece of Applicant's packaging material;

FIG. 2 is a pictorial view of the packaging material in a first fold;

FIG. 3 is a pictorial view of the packaging material in a second fold;

FIG. 4 is a pictorial view of the packaging material folded;

FIG. 5 is a pictorial view of Applicant's packaging material in the form of bubble wrap with a mesh or tin foil backing;

FIG. 6 is a cross section side view of the receptacle with a battery being inserted;

FIG. 7 is perspective view with a battery inserted and the receptacle sealed;

FIG. 8 is a block diagram of a method of manufacturing the packaging material;

FIG. 9 is a perspective view of a bucket receptacle; and

FIG. 10 is a perspective view of a banker's box receptacle.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

The present invention relates to packaging materials that can be made into various storage receptacles for use in holding lithium batteries. The storage receptacle and method of manufacturer utilizes an admixture of hydrated amount of super absorbent polymer in an amount sufficient to extinguish a battery fire.

Battery fires present different and unique problems pertaining to how these fires should be extinguished and suppressed. While water is commonly employed to extinguish fires because it can quickly cool down the burning material, water does not necessary work on a battery fire especially if the water is conductive water which may short circuit battery and/or operating device.

In the preferred embodiment of the present invention, an admixture of a super absorbent polymer and water is placed with a receptacle that stores a battery or a component that contains a battery. The aqueous admixture of the super absorbent polymer and water having properties which enable the super absorbent polymer and water admixture to be confined to a particular area because of its relatively high viscosity. The properties of the admixture, in particular its viscosity, enable the admixture to remain on vertical, horizontal, and curved surfaces formed by the receptacle. Unlike pure water, the admixture does not provide an electrically conductive path. The present invention adds a predetermined amount of the super absorbent polymer to a predetermined amount of water to obtain an admixture which has properties that enable the admixture to suppress the spread of a battery fire and extinguish any fire that has attached itself to the individual. A ratio of about 4 grams of said super absorbent polymer is hydrated with about 0.1 gallons of water to suppress a lithium battery fire within the cavity.

The admixture of Applicant's potassium based super absorbent polymer, marketed under the trademark FireIce®, and water has physical and chemical properties which enable the admixture to entrap and retain the noxious and/or toxic gasses and prevent the release of these gases into the atmosphere.

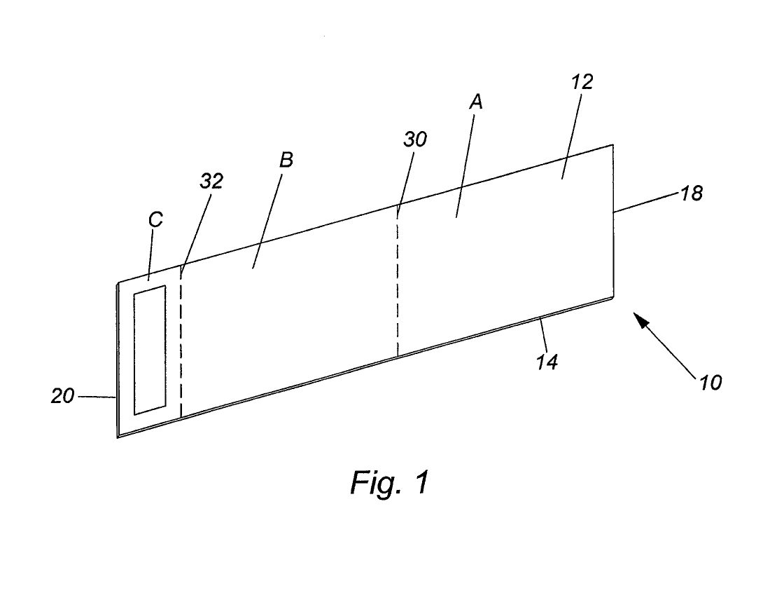

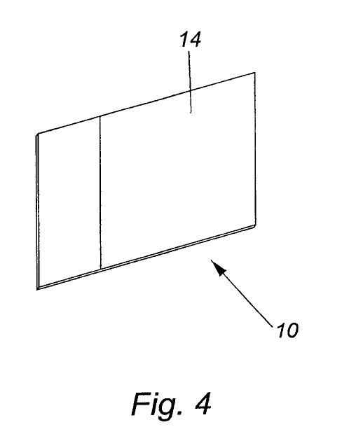

Referring now to FIGS. 1-4, set forth is an exemplary embodiment of packaging used in the form of a fire suppressing storage receptacle for batteries is illustrated. A receptacle 10 is constructed from a first sidewall 12 spaced apart from a second sidewall 14 having a predetermined amount of super absorbent polymer 16 positioned therebetween. The sidewalls may assimilate a layered structure wherein the receptacle is formed from a material selected from the group consisting of low density polypropylene, polyurethane, or polyisoprene. The use of a flexible material is selected for its ability to be flexible and leak resistant with an ability to hold the hydrated material over a long period of time without evaporation. The admixture is a biodegradable, super absorbent, aqueous based cross linked modified polyacrylamides/potassium acrylate polymers. Other polymers may be used but not with the same quality level, examples of these polymers are cross-linked modified polyacrylamides/sodium acrylate, carboxy-methylcellulose, alginic acid, cross-linked starches, and cross-linked polyaminoacids.

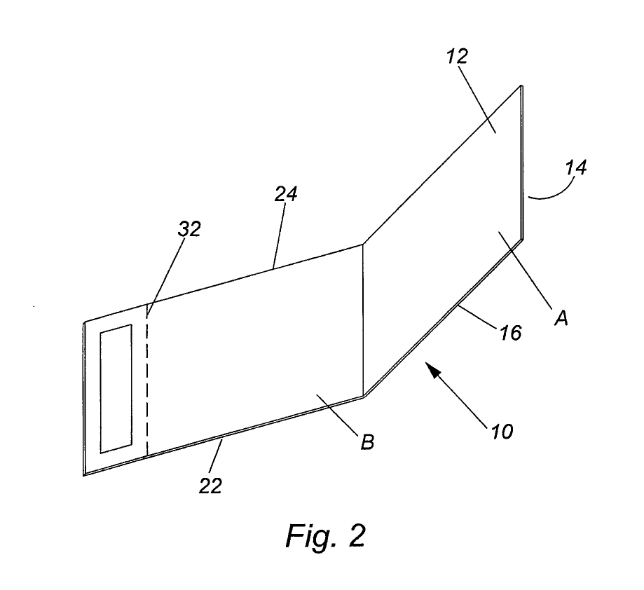

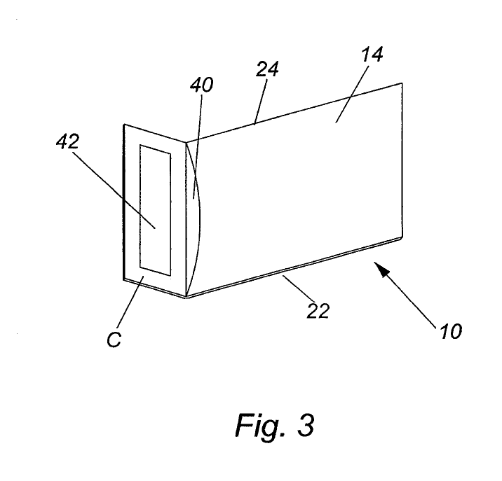

The sidewalls 12, 14 are sealed along first and second end edges 18, 20 and first and second side edges 22, 24. Each said sidewall is further defined as three sections, namely section A defined as the portion between end edge 18 and fold line 30, section B defined by fold line 30 and fold line 32, and section C defined as the portion between end edge 20 and fold line 32. FIG. 2 depicts Section A folded onto Section B and FIG. 3 depicts side edge 22 and 24 secured together. Securement is by weldment, adhesive, or any other type of bonding, the securement forms a cavity opening 40 for which the batteries may be inserted. Section C can be placed over the cavity opening and secured to the second sidewall using adhesive 42, hook and pile, or any other securement material that can be used to fasten the sections together. A sheet of non-woven polypropylene material can be placed between the two sheets to prevent gravity settling of the admixture. A preferred polypropylene material about 12 ounces, and a second backing sheet of polyester can be employed preferably about 0.57 mils thick.

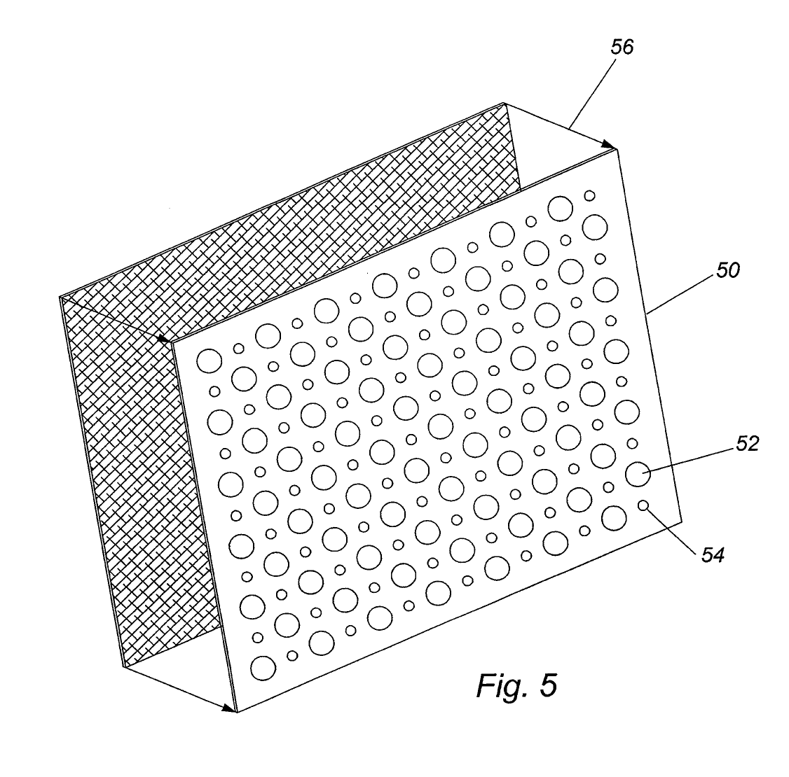

FIG. 5 depicts an alternative embodiment wherein the admixture is placed within a formation commonly known as bubble wrap. In this configuration, a flexible sheet of material 50 includes raised cavities 52 which may be uniform shaped or have at least one other cavities shape 54 positioned adjacent thereto. In this embodiment, each of the cavities is filled with an admixture which operates as padding when the material is placed around any product, and provide fire protection when placed around a battery or the like device that is capable of catching fire. Alternatively, alternate cavities 54 may be filled with the admixture and cavities 52 filled with air. The configuration provides for a lightweight packaging material yet still provides fire protection to the batteries placed with the packing material. In operation, should a battery placed within the packing overheat, with or without an attendant fire, the heat causes the plastic to melt releasing the admixture directly onto the heat source. In particular, should a battery catch fire, the heat of the battery fire will cause the packaging to melt at the immediate area of the fire causing the release of the admixture for extinguishing the fire. The admixture will further adhere to the battery providing a cooling effect so as to suppress further arcing within the battery. The backing for the bubble wrap material may include a mesh or tin foil sheet 56 that is capable of arresting small explosions. The mesh may be metal such as stainless steel wire, Kevlar, carbon fiber, basalt or the like material capable of containing small explosions such as a bursting battery. The flexible sheet of material 50 and mesh sheet 56, as well as the aforementioned dual sidewall construction, may be placed in most any shipping container as liners or simply used a wrapping material. For instance, the packaging sheet may be used as a liner for valuable machinery shipments, such as engines. In particular, the cost of aviation jet engines is extremely high and use of the packaging sheet can be used to protect the engine from fire during storage and shipping. It should be noted that having a fire suppression packaging position at the point of combustion serves to protect the remaining cargo. Another example is that of banker boxes uses for long term storage of paper files. The packaging of the instant invention is preferably used as a liner with the banker box providing close proximity to the paper files.

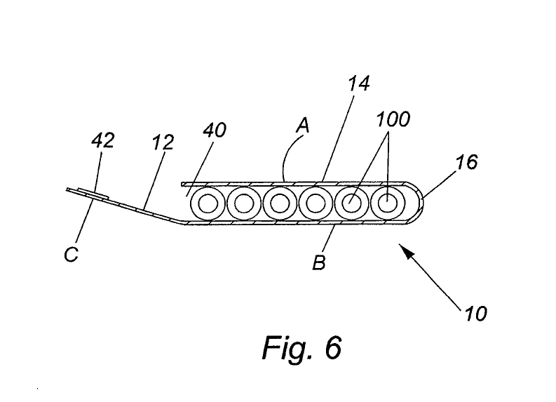

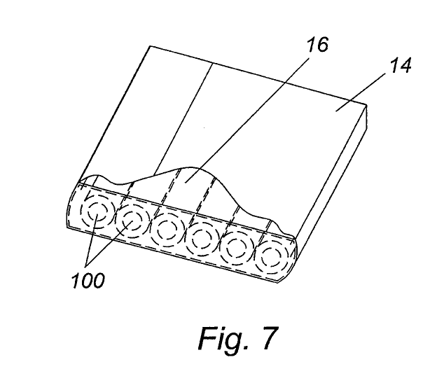

Referring to FIG. 6, depicted is the receptacle 10 sidewalls 12 and 14 with the admixture 16 sealed therebetween. Batteries 100 are depicted within the cavity 40 for storage, shipping or placement during the battery recharging cycle. Should a stored battery overheat at least a portion of the receptacle will breach wherein the inner sidewall 12 will allow the hydrated polymer 16 to flow into the cavity 40 and address the overheated battery. It should be noted that the size of the cavity can be reduced for smaller batteries or enlarged to store items that house batteries such as laptop computers. FIG. 7 depicts section C of the sidewalls overlapping section A so as to seal the batteries within the cavity 40. The flap depicted by section C can be inserted into the cavity, or attached thereto by an adhesive means 42. The super absorbent polymer 16 is potassium based and hydrated at a level to make a non-conductive admixture. A ratio of 4 grams of super absorbent polymer is hydrated with 0.1 gallons of water is suggested as suitable to suppress a lithium battery fire within the cavity. In particular the super absorbent polymer is an admixture of polyacrylamides/potassium acrylate marketed under the trademark FIREICE®. Unique to this admixture is the ability of the hydrated super absorbent polymer to suppress airborne organic compounds and airborne metals from an overheated battery.

Should the admixture leak, it will not affect any electrical component and clean-up can be performed by vacuuming the material once dried. Since the admixture of solid super absorbent polymer and water entraps the particulates and noxious and/or toxic gasses, the clean up is substantially easier and quicker than the clean up from other methods of fire suppression and extinguishing.

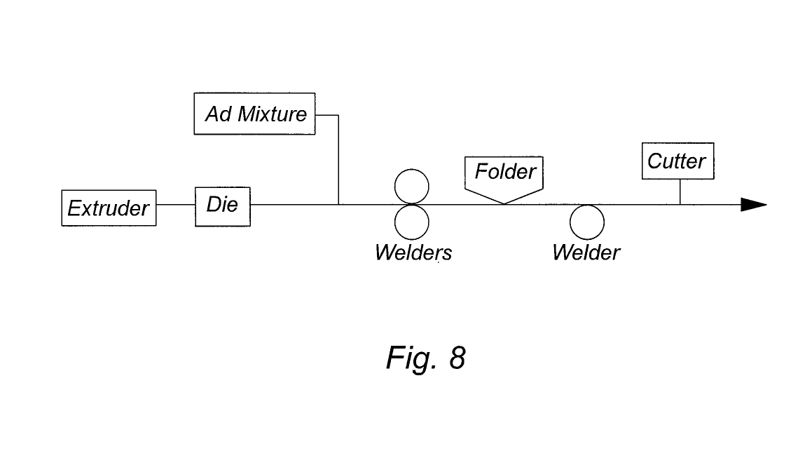

Referring to FIG. 8, the receptacle is manufactured by forming each sidewall from extruded plastic placed through a die to form a cavity for receipt of the admixture. The admixture is added to the cavity and welders seal the admixture with the cavity, or cavities if a bubble wrap support sheet is employed. The sidewalls are then folded and welded along the side edges to form a receptacle for receipt of a battery(s). The material is directed through a cutter to separate the receptacle from adjoining receptacles. The receptacle includes a flap that operates as a releasable seal for sealing at least one battery within the cavity; the seal can be adhesive tape or a hook and loop attachment.

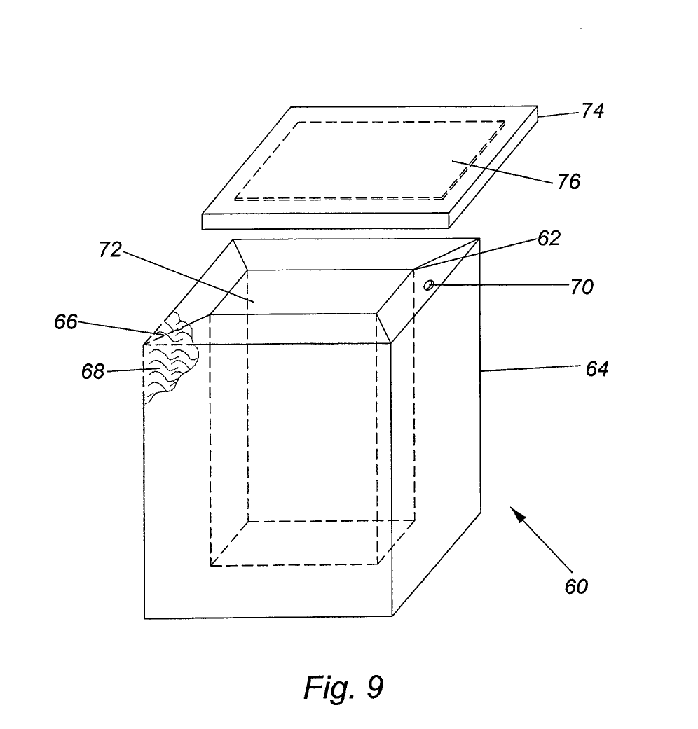

FIG. 9 is a perspective view of a bucket receptacle 60 have an inner liner 62 preferably made of a rigid material spaced apart from an outer liner 64, also made of a rigid material. In the preferred embodiment the liners are constructed from plastic such as high-density polyethylene (HDPE), essentially forming a bucket within a bucket. The space 68 formed between the inner and outer liner 62, 64 is filled with hydrated super absorbent polymer. The admixture need not be sealed where the admixture can be rehydrated with water; sealed with a fill port 70 where the admixture can be rehydrated by placing water through the fill port; or sealed wherein water evaporation is impeded. Contents placed in the cavity 72 formed by the inner liner 62 are protected from fire resulting from both internal and external sources. A lid 74 includes a liner 76 of the admixture. The bucket receptacle allows economy in use by providing a container having a reusable lid and durable liners 62, 64.

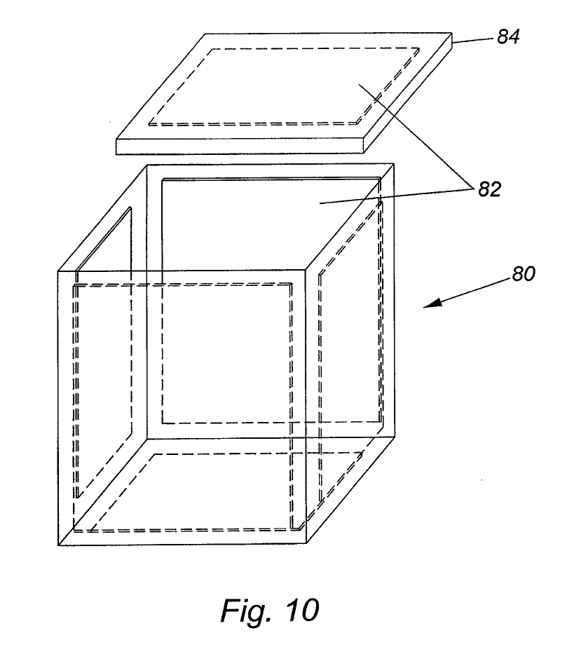

FIG. 10 is a perspective view of a banker's box receptacle 80 which resembles the conventional banker's box cardboard material on the exterior but includes liners 82 made of thin wall plastic encapsulating non-woven polypropylene material therebetween. The non-woven polypropylene is saturated with the hydrated admixture which prevents gravity settling. The admixture, which forms a gel, adheres to the non-woven polypropylene material to prevent settling when placed in a vertical position, such as along the sidewalls. The banker box receptacle 80 is a conventional box having for sidewalls and a bottom wall. A lid 84 includes a liner 82 wherein files placed within the receptacle are surrounded by the admixture. In this configuration, should a fire occur, the heat from the fire will breach the thin wall plastic encapsulating the admixture. The admixture is exposed to saturate the fire, leading to extinguishment.

In some embodiments, the fire suppressant or compositions thereof is a biodegradable, super absorbent, aqueous based polymer. The fire suppressant or compositions thereof can be any known or conventional fire suppressants, including biodegradable, super absorbent, aqueous based polymers. Examples of these polymers are cross-linked modified polyacrylamides/potassium acrylate or polyacrylamides/sodium acrylate. Other suitable polymers include, albeit not limited to, carboxy-methylcellulose, alginic acid, cross-linked starches, and cross-linked polyaminoacids. Examples of known fire suppressants include without limitation, those marketed under the brand name of FIREICE marketed by GelTech, Barricade II marketed by Barricade International; Thermo Gel 500p marketed by Thermo Industries; AFG Firewall marketed by NoChar; Phos-Chek, AquaGel-K, Focstop-K or Insul-8 marketed by ICL Performance Products; Blaze Tamer 380 marketed by Bio Central Labs; and Tetra KO marketed by Earth Clean Corporation. As used herein, a “fire suppressant” composition is meant to be inclusive of all components of the composition. In some embodiments, the fire suppressant composition comprises one or more fire suppressant compounds. In other embodiments, the fire suppressant composition comprises one or more common components of fire suppressant formulations, such as: fire suppressant salts, known or conventional fire suppressants, corrosion inhibitors, spoilage inhibitors, foaming agents, non foaming agents, flow conditioners, stability additives, thickening agents, pigments, dyes or the like.

The FireIce admixture is capable of suppressing harmful air emissions released from electrical files. A test of the admixture has been performed on electrical fires involving copper and aluminum cables.

### 1. Test Description

A total of five field test air sampling collections were undertaken on Jan. 18, 2011, at the High Current Laboratory (HCL) to evaluate the air emissions released from the application of Applicant's super absorbent polymer marked under the trademark FireIce® to artificially induced faults generated using copper and aluminum cables. The five test scenarios were air sampled for airborne metals and organics. The description of the tests is given in Table 1.

TABLE 1
Test description

| Test # | Shot # | Test description | Cable description |
|---|---|---|---|
| 1 | 119 | New cables with copper conductor artificially | coned 500 kcmil Cu 600 V |
| | | faulted to create arc with no FireIce ® added. | EAM/LSNH installed in |
| | | Target fault current: 2 kA. | coned precast concrete |
| | | Fault duration: until fault self-extinguished. | distribution box type B-3.6 |
| 2 | 120 | New cables with copper conductor artificially | coned 500 kcmil Cu 600 V |
| | | faulted to create arc with FireIce ® added at | EAM/LSNH installed in |
| | | the on-set of arc. | coned precast concrete |
| | | Target fault current: 2 kA. | distribution box type B-3.6 |
| | | Fault duration: until fault self-extinguished. | |
| 3 | 121 | New cables with copper conductor artificially | coned 500 kcmil Cu 600 V |
| | | faulted to create arc with FireIce ® added at | EAM/LSNH installed in |
| | | the on-set of arc - this was a repeat of test #2 | coned precast concrete |
| | | due to poor arc generation and non- | distribution box type B-3.6 |
| | | propagation of arc. | |
| | | Target fault current: 2 kA. | |
| | | Fault duration: until fault self-extinguished. | |
| 4 | 122 | New cables with aluminum conductor | coned 350 MCM Al 600 V |
| | | artificially faulted to create arc with FireIce ® | EPR installed in coned |
| | | added at the on-set of arc. | precast concrete distribution |
| | | | box type B-3.6 |
| 5 | 123 | New cables with aluminum conductor | coned 350 MCM Al 600 V |
| | | artificially faulted to create arc with | EPR installed in coned |
| | | “FireIce ®” added to concrete box to cover | precast concrete distribution |
| | | faulted cables prior to high current being | box type B-3.6 |
| | | applied to create arc. | |
| | | Target fault current: 2 kA. | |
| | | Fault duration: until fault self-extinguished. | |

In all the tests the cables were installed at the bottom of the concrete box, and the fault between the cables was created using a fuse wire. The approximate dimensions of the interior volume of the concrete box are: 33″×33″×24″. One calorimeter was installed above the concrete box to measure the incident energy generated by the fault.

The sampling equipment consisted of five separate sampling trains, each with a sampling pump drawing air through various air sampling components using a calibrated mass flow controller to maintain constant flow. The sampling time for each train was two minutes during each of the 5 arc test scenarios. For each sampling train a flow rate was selected based on the type of air sample being collected. The five sampling trains consisted of the following components and the air flow rate utilized:

1. A sampling train consisting of a MCE (mixed cellulose ester) filter in a cartridge filter holder for aerosol collection generated during the arc. The air flow rate through the filter was set to 1 L/min.

2. A sampling train for organic compounds using two Carbotrap™ 300 sampling tubes in series (front-back arrangement) was placed with the front sampling tube inlet at the edge of the concrete bunker. The air flow rate for the organics sampling tube train was 0.050 L/min.

3. A sampling train consisting of three impingers in series with 1M nitric acid in the first two impingers and an empty third impinger was used to trap airborne metals. The metals train air flow rate was set to 0.50 L/min.

4. A sampling train identical to the one described in 3 but with 0.5M KOH added to the first two impingers and an empty third impinger was setup plus an additional Carbotrap™ 300 organic compound sampling train as described in 2 was added in series to the outlet of the last impinger. The air sampling flow rate was set to 0.25 l/min for this train.

5. A final sampling train consisting of 3 impingers in series as described in 3 but with KOH added to the first two impingers and an empty third impinger to capture acidic species possibly generated during the FireIce® tests. The air sampling flow rate was set to 0.25 L/min for this train.

### 2. Organic Compound Sampling Results—Carbotrap™ 300 Tube Analyses

The organic compounds released to air were captured using Carbotrap™ 300 tubes after the air sample passed through a KOH impinger train. The sampling flow rate was 0.25 L/min. The total mass of organic compounds collected during each of the five arc fault tests are given in Table 2. The organic compounds identified in the air samples are summarized in Table 3.

TABLE 2
Total Mass of Organic Compounds Collected on Carbotrap ™ 300
Sample Tubes and Estimated FireIce ® Inhibition
Ratio for Organic Compound Release

| | | | Minimum |
|---|---|---|---|
| | | Total Mass of | Removal |
| | | Organics Collected | Efficiency |
| | | on Carbotrap ™ | Compared to |
| Test Number & Description | | 300 Tubes (ng) | Test 1 |
| 1 | Pair of New Neoprene Copper | 615 | — |
| | Cables - No FireIce ® Applied | | |
| 2 | Pair of New Neoprene Jacketed | 189 | 3.2 |
| | Copper Cables - FireIce ®- | | |
| | Added at On-Set of Arc | | |
| 3 | Pair of New Neoprene Jacketed | 138 | 4.5 |
| | Copper Cables - FireIce ®- | | |
| | Added at On-Set of Arc (Repeat) | | |
| 4 | Pair of New Neoprene Jacketed | No Organic | >61.5* |
| | Aluminum Cables - FireIce ® | Compounds | |
| | Added at On-Set of Arc | Detected | |
| 5 | Pair of New Neoprene Jacketed | No Organic | >61.5* |
| | Aluminum Cables - FireIce ® | Compounds | |
| | Added Prior to Arc Generation | Detected | |

Note:
*Assumed minimum removal efficiency is assumed to be >61.5 as detection limit for any single organic compound is 10 ng.

TABLE 3
Organic Compounds Identified in High Flow Samples

| | | Organic Compounds Collected | |
|---|---|---|---|
| | | on Carbotrap ™ 300 Tubes | Total Organic |
| | | Passage Through KOH | Compound Mass |
| Test Number & Description | | Impingers | (Front + Back) (ng) |
| 1 | Pair of New Neoprene Copper | ethane-1-chloro-1,1 difluoro* | 48000* |
| | Cables - No FireIce ® Added | 2-butene, 2-methyl | 18 |
| | | 1,3-butadiene, 2-methyl | 40 |
| | | 1,3 pentadiene | 35 |
| | | 1,4 pentadiene | 14 |
| | | cyclopentane | 23 |
| | | 1-pentene, 2-methyl | 36 |
| | | benzene | 62 |
| | | 1,4-cyclohexadiene | 25 |
| | | 3-hexen-1-ol | 28 |
| | | toluene | 237 |
| | | ethylbenzene | 48 |
| | | styrene** | 2740** |
| | | a-methyl styrene** | 53** |
| 2 | Pair of New Neoprene Jacketed | ethane-1-chloro-1,1-difluoro | 68* |
| | Copper Cables - FireIce ®- | 1,3-butadiene | 14 |
| | Added at On-Set of Arc | 1-pentene, 2-methyl | 21 |
| | | propane, 2-methyl-1-nitro | 31 |
| | | 3-heptene | 8 |
| | | benzene | 62 |
| | | butane, I-chloro-2-methyl | 25 |
| | | styrene** | 99** |
| | | unknown | 28 |
| 3 | Pair of New Neoprene Jacketed | ethane-1-chloro-1,1-difluoro | 264* |
| | Copper Cables - FireIce ®- | 1-propene, 2-methyl | 16 |
| | Added at On-Set of Arc (Repeat) | 1,3-butadiene | 40 |
| | | 2-butene, 2-methyl | 12 |
| | | 1-pentene, 2-methyl | 25 |
| | | benzene | 34 |
| | | unknown | 11 |
| 4 | Pair of New Neoprene Jacketed | No organic compounds | 0 |
| | Aluminum Cables - FireIce ® | detected on both front and back | |
| | Added at On-Set of Arc | Carbotrap ™ 300 tubes | |
| 5 | Pair of New Neoprene Jacketed | No organic compounds | 0 |
| | Aluminum Cables - FireIce ® | identified on both front and back | |
| | Added Prior to Arc Generation | Carbotrap ™ 300 tubes | |

Notes:
*The ethane-1-chloro-1,1-difluoro is suspected to be contamination resulting from the partial decomposition of impinger train holder used during testing. The Freon HCFC 142b released during tests 1 to 3 is the trapped blowing agent used to make the closed cell foam. The foam was used to support and secure the impinger trains. Not included in organic compound mass reported.
**The styrene and a-methyl styrene are unintentional contaminants generated from the destruction of the aerosol filter holder used during the first arc fault Test-1. The filter- holder was too close to the arc-fault zone and did not survive Test-1. The styrene values are not included in organic compound mass reported.

### Direct Air Sampling

The total mass of organic compounds in the air samples collected directly on to Carbotrap™ 300 tubes during each of the five arc fault tests are given in Table 4. The organic compounds captured with the Carbotrap™ 300, tubes and subsequently detected during analysis are listed in Table 5. The sampling flow rate was 0.05 L/min.

TABLE 4
Total Mass of Organic Compounds on Direct Air
Sample onto Carbotrap ™ 300 Tubes
and FireIce ® Inhibition Ratio

| | | Total Mass of | Minimum |
|---|---|---|---|
| | | Organics Collected | Removal |
| | | on. Carbotrap ™ | Efficiency |
| | | 300 Tubes (Front + | Compared to |
| Test Number & Description | | Back) (ng) | Test 1 |
| 1 | Pair of New Neoprene Jacketed | 158 | — |
| | Copper Cables - No FireIce ® | | |
| 2 | Pair of New Neoprene Jacketed | 65 | 2.4 |
| | Copper Cables - FireIce ®- | | |
| | Added at On-Set of Arc | | |
| 3 | Pair of New Neoprene Jacketed | 15 | >10 |
| | Copper Cables - FireIce ®- | | |
| | Added at On-Set of Arc (Repeat) | | |
| 4 | Pair of New Neoprene Jacketed | None | >15.8 |
| | Aluminum Cables - FireIce ® | Detected | |
| | Added at On-Set of Arc | | |
| 5 | Pair of New Neoprene Jacketed | 10 | 15.8 |
| | Aluminum Cables - FireIce ® | | |
| | Added Prior to Arc Generation | | |

The total organic compound concentration measured directly with the Carbotrap™ 300 tubes associated with the copper cable arc fault in Test-1 is estimated to be 1.6 mg/m3 without the application of FireIce®. For Test-2 through Test-5 the organic compound concentrations are estimated to be 0.6 mg/m3, 0.15 mg/m3, 0.0 mg/m3 and 0.1 mg/m3, respectively.

The FireIce® application is effective in reducing organic emissions for both the copper cables and the aluminum cables. The removal efficiencies estimated in Table 2 and Table 4 compare well. The application of FireIce® reduces organic emissions when applied with the arc fault is active. The presence of external contamination confirms the effective organic sampling in the vicinity of the arc fault during the five tests.

TABLE 5
Organic Compounds Identified in Direct Air Samples
Collected on Carbotrap ™ 300 Tubes

| | | Organic Compounds Collected | Organic Compound |
|---|---|---|---|
| Test Number &Description | | on Carbotrap ™ 300 Tubes | Mass (ng/tube) |
| 1 | Pair of New Neoprene Copper | Ethane-1-chloro-1,1 difluoro* | 53* |
| | Cables - No FireIce ® Added | 1-pentene, 2-methyl | 15 |
| | | Benzene | 64 |
| | | toluene** | 41 |
| | | Styrene | 70 |
| | | methyl styrene** | 217* |
| | | isobutyl nitrile | 11 |
| | | propane, 2-methyl-1-nitro | 14 |
| | | unknown | 13 |
| 2 | Pair of New Neoprene Jacketed | 1-propene, 2-methyl | 8 |
| | Copper Cables - FireIce ®- | 1,3 butadiene | 16 |
| | Added at On-Set of Arc | 2-butene, 2-methyl | 8 |
| | | 1-pentene, 2-methyl | 23 |
| | | unknown | 10 |
| 3 | Pair of New Neoprene Jacketed | 1-pentene, 2-methyl | 15 |
| | Copper Cables - FireIce ®- | | |
| | Added at On-Set of Arc (Repeat) | | |
| 4 | Pair of New Neoprene Jacketed | No organic compounds | 0 |
| | Aluminum Cables - FireIce ® | detected on both front and back | |
| | Added at On-Set of Arc | Carbotrap ™ 300 tubes | |
| 5 | Pair of New Neoprene Jacketed | No organic compounds | 0 |
| | Aluminum Cables - FireIce ® | identified on both front and back | |
| | Added Prior to Arc Generation | Carbotrap ™ 300 tubes | 10 |
| | | Unknown peak (Front tube only) | |

Notes:
*The ethane-1-chloro-1,1-difluoro is suspected to be contamination resulting from the partial decomposition of impinger train holder used during testing. The Freon HCFC 142b released during testing is the trapped blowing agent used to make the closed cell foam. The foam was used to support and secure the impinger trains. The Freon was not included in organic compound mass reported.
**The styrene and a-methyl styrene are unintentional contaminants generated from the destruction of the aerosol filter holder used during the first arc fault Test-1. The filter- holder was too close to the arc-fault zone and did not survive Test-1. The styrene values are not included in organic compound mass reported.

TABLE 6
Metals Analysis Results (PPM) Filter
Pack Sampling ~2 m Above Arc Fault

| | Blank | Test 2 | Test 3 | Test 4 | Test 5 |
|---|---|---|---|---|---|
| Metal | (Avg) | (Cu) | (Cu) | (Al) | (Al) |
| Al | <0.5 | 3.15 | 6.81 | 1.48 | <0.5 |
| Ca | 2.15 | 1.80 | 4.96 | 2.52 | 1.93 |
| Cu | <1.5 | 94.8 | 312 | 1.98 | <1.5 |
| Fe | <0.25 | <0.25 | 2.85 | <0.25 | <0.25 |
| K | 67 | 68 | 39 | 28 | 23 |
| Mg | 0.19 | 8.4 | 18.9 | 0.25 | <0.1 |
| Na | <2.5 | <2.5 | 5.8 | <2.5 | <2.5 |
| P | <1 | <1 | 1.2 | <1 | <1 |
| S | <1 | <1 | 3.7 | <1 | <1 |
| Si | <1 | 4.3 | 20.5 | <1 | <1 |
| Ag | <0.005 | <0.005 | 0.007 | <0.005 | <0.005 |
| As | <0.05 | <0.05 | <0.05 | <0.05 | <0.05 |
| B | <0.05 | <0.05 | <0.05 | <0.05 | <0.05 |
| Ba | 0.007 | 0.012 | 0.022 | 0.008 | 0.006 |
| Bi | <0.005 | <0.005 | <0.005 | <0.005 | <0.005 |
| Be | <0.005 | <0.005 | <0.005 | <0.005 | <0.005 |
| Cd | <0.005 | <0.005 | <0.005 | <0.005 | <0.005 |
| Co | <0.005 | <0.005 | <0.005 | <0.005 | <0.005 |
| Cr | <0.005 | <0.005 | <0.005 | <0.005 | <0.005 |
| Cs | <0.005 | <0.005 | <0.005 | <0.005 | <0.005 |
| Li | <0.005 | <0.005 | 0.013 | <0.005 | <0.005 |
| Mn | 0.005 | 0.006 | 0.053 | 0.007 | 0.006 |
| Mo | <0.005 | <0.005 | <0.005 | <0.005 | <0.005 |
| Ni | 0.010 | 0.013 | 0.024 | 0.016 | 0.011 |
| Pb | <0.005 | 1.93 | 4.79 | 0.063 | 0.015 |
| Sb | 0.003 | 2.17 | 5.19 | 0.072 | 0.017 |
| Se | <0.05 | <0.05 | <0.05 | <0.05 | <0.05 |
| Sn | 0.029 | 0.036 | 0.028 | 0.006 | 0.005 |
| Sr | 0.007 | 0.006 | 0.028 | 0.009 | 0.006 |
| Th | <0.005 | <0.005 | <0.005 | <0.005 | <0.005 |
| Ti | 0.151 | 0.122 | 0.309 | 0.007 | 0.007 |
| Th | <0.005 | <0.005 | <0.005 | <0.005 | <0.005 |
| W | <0.005 | <0.005 | <0:005 | <0.005 | <0.005 |
| Zr | <0.005 | <0.005 | <0.005 | <0.005 | <0.005 |
| V | <0.05 | <0.05 | <0.05 | <0.05 | <0.05 |
| Zn | 0.037 | 1.22 | 3.02 | 0.054 | 0.042 |
| Hg | <0.005 | <0.005 | <0.005 | <0.005 | <0.005 |
| U | <0.005 | <0.005 | <0.005 | <0.005 | <0.005 |

TABLE 7
Metals Analysis Results (PPM) from Acid Impinger Sampler Train

| Metal | MDL | Test I (Cu) | Test 2 (Cu) | Test 3 (Cu) | Test 4 (Al) | Test 5 (Al) |
|---|---|---|---|---|---|---|
| Al | <0.01 | 0.145 | 0.272 | 0.330 | 0.328 | 0.640 |
| Ca | <0.01 | 0.485 | 1.30 | 0.388 | 0.523 | 0.094 |
| Cu | <0.01 | 0.22 | 0.918 | 0.816 | 0.66 | 0.062 |
| Fe | <0.005 | 0.02 | 0.056 | 0.023 | 0.028 | 0.025 |
| K | <0.01 | 1.24 | 0.896 | 0.644 | 77.8 | 13000 |
| Mg | <0.002 | 0.042 | 0.134 | 0.056 | 0.318 | 0.012 |
| Na | <0.05 | 0.951 | 0.727 | 1.78 | 0.905 | 10.5 |
| P | <0.02 | <0.02 | 0.049 | <0.02 | <0.02 | <0.02 |
| S | <0.05 | 0.043 | 0.070 | 0.099 | 0.043 | 0.504 |
| Si | <0.1 | 0.303 | 0.48 | 1.10 | 0.49 | 21.4 |
| Ag | <0.0001 | 0.004 | 0.005 | 0.004 | 0.005 | 0.002 |
| As | <0.001 | <0.001 | <0.001 | <0.001 | <0.001 | <0.001 |
| B | <0.025 | 0.853 | 0.638 | 1.61 | 0.922 | 2.88 |
| Ba | <0.0001 | 0.006 | 0.008 | 0.007 | 0.006 | 0.002 |
| Bi | <0.001 | <0.001 | <0.001 | <0.001 | <0.001 | <0.001 |
| Be | <0.001 | <0.001 | <0.001 | <0.001 | <0.001 | <0.001 |
| Cd | <0.0001 | <0.0001 | <0.0001 | <0.0001 | 0.0002 | <0.0001 |
| Co | <0.0001 | 0.0001 | 0.0004 | <0.0001 | 0.0002 | 0.0001 |
| Cr | <0.0001 | 0.0007 | 0.0009 | 0.0006 | 0.0006 | 0.019 |
| Cs | <0.0001 | <0.0001 | <0.0001 | <0.0001 | 0.002 | 0.819 |
| Li | <0.001 | <0.001 | <0.001 | <0.001 | <0.001 | 0.004 |
| Mn | <0.0001 | 0.001 | 0.002 | 0.0006 | 0.0010 | 0.015 |
| Mo | <0.0001 | 0.0002 | 0.0002 | 0.0003 | 0.0002 | 0.0020 |
| Ni | <0.0001 | 0.002 | 0.001 | 0.002 | 0.002 | 0.001 |
| Pb | <0.0001 | 0.003 | 0.003 | 0.008 | 0.009 | 0.008 |
| Sb | <0.001 | 0.002 | 0.002 | 0.007 | 0.003 | <0.001 |
| Se | <0.001 | <0.001 | <0.001 | <0.001 | <0.001 | 0.004 |
| Sn | <0.0001 | 0.0004 | 0.0003 | 0.0002 | 0.0005 | 0.0020 |
| Sr | <0.0001 | 0.002 | 0.005 | 0.002 | 0.003 | 0.001 |
| Th | <0.0001 | <0.0001 | <0.0001 | <0.0001 | <0.0001 | <0.0001 |
| Ti | <0.0001 | 0.001 | 0.004 | 0.002 | 0.002 | 0.014 |
| Tl | <0.0001 | <0.0001 | <0.0001 | <0.0001 | <0.0001 | <0.0001 |
| W | <0.0001 | <0.0001 | <0.0001 | <0.0001 | 0.0001 | 0.037 |
| Zr | <0.0001 | 0.0002 | 0.0008 | 0.0007 | 0.0007 | 0.027 |
| V | <0.0001 | <0.0001 | <0.0001 | <0.0001 | <0.0001 | 0.0002 |
| Zn | <0.0001 | 0.01 | 0.009 | 0.01 | 0.021 | 0.003 |
| Hg | <0.0001 | <0.0001 | <0.0001 | <0.0001 | <0.0001 | <0.0001 |
| U | <0.0001 | <0.0001 | <0.0001 | <0.0001 | <0.0001 | <0.0001 |

A 2-liter air sample was taken through a filter pack at about 2 meters above each arc test. Each available exposed filter was analyzed for metals and other elements. The results for 38 element analyses are presented in Table 6.

Some key observations are noted from filter analysis for the Test-2 through Test-5 data available in Table 6: A key result noted is the below detection of aluminum for Test 5 compared to a measurable detection in Test 4. Both tests used new aluminum cables for the arc fault but in the Test 5 case the fault zone was encapsulated in FireIce® prior to arc fault generation whereas for Test 4 the arc fault was initiated into air and then FireIce® was added to quench the arc fault. The lead (Pb), antimony (Sb), magnesium (Mg), copper (Cu), and calcium (Ca) results add confirmation to the reduction of released metals with the arc fault encapsulated.

The counter ion for FireIce® is potassium (K). For all four arc fault tests, the filter analysis did not detect potassium above the nominal background concentration of potassium present on the filter prior to exposure. This is evidence that FireIce® did not undergo detectable degradation during the arc faults where FireIce® was applied.

Test 2 and Test 3 were essentially duplicate tests using new neoprene jacketed copper cables for the arc fault with Test 3 having the more sustained arc fault. The procedure for applying FireIce® was the same for both tests. At the on-set of the arc fault the addition of FireIce® was begun and continued until the concrete cell was about ½ full. For the more sustained arc fault (Test 3) the key metals from the vaporized copper cable as measured with the filter pack were about 3 to 4 times higher than the metals released in the much shorter arc period of Test 2. Key metals released were aluminum (1.7%), copper (80%), magnesium (4.8%), zinc (0.8%), lead (1.2%), calcium (1.3%) and antimony (1.3%) with remaining components at <1% to only present at trace levels.

The estimated airborne total metals concentration for Test 3 is 0.17 g/m³ and for Test 2 is 0.058 g/m³. Similarly for the aluminum cables the estimated airborne total metals concentration for Test 4 is 0.003 g/m³ and for Test 5 is 0.001 g/m³.

For comparison the Ontario Ministry of Labor time-weighted average exposure concentration (TWAEC) for a variety of fumes and particulate, ranges from 0.003 to 0.01 g/m³ for 40-hr work week and for short term exposures, the particulate concentrations range from 0.005 to 0.02 g/m³ for a maximum 15 minute continuous exposure depending on the fume and particulate present.

Observations from the metals train analysis for Tests 1 through 5 are summarized below and are based on the metal/element analysis data present in Table 7.

The high level of potassium in the Test 5 results were from the entrainment of airborne FireIce® into the first impinger as the arc generated gas that ejected some of the FireIce® material into the air. This is confirmed by the increase in silica, sodium and sulfur.

For Test 4 a significant level of copper (0.66 ppm) is measured as copper residue from Tests 1 to 3 is released during the aluminum cable arc fault. However in Test 5 very little copper is detected (>10× less detected 0.062 ppm) with the FireIce® encapsulating the arc fault zone. This also confirmed by the similar reduction in magnesium detected.

The impinger samples collected similar amounts of metals for the copper cable arc fault tests. The metal concentration levels were and are given in Table 7.

The application of FireIce® to neoprene jacketed copper and aluminum cables is effective in reducing airborne organic compounds and also airborne metals. Removal efficiencies from 2 times to greater than 15 times can be expected when added to an active arc fault. For a FireIce® encapsulated arc fault greater than 60 times removal of metals and arc generated arc products is possible based on the five tests performed. The optimum admixture is ratio of 100 grams of FireIce to 2.5 gallons of clean clear water.

The method of manufacturing a fire suppressing receptacle for lithium batteries comprises: forming a first rectangular shaped sidewall from flexible plastic, said first sidewall having a first longitudinal side edge spaced apart from a second longitudinal side edge extending between said first and second end edges; forming a second rectangular shaped sidewall from flexible plastic, said second sidewall forming a mirror image of said first sidewall; securing at least two side edges of said first and second shaped sidewall together forming a first cavity; inserting an admixture of hydrated super absorbent polymer into said first cavity and sealing said first cavity; and securing at least a portion of each side edge together forming a second cavity; wherein a lithium battery is insertable into the second cavity whereby a lithium battery breach will rupture the sidewall forming said second cavity allowing the admixture to flow to the lithium battery breach. The method includes a releasable seal placed in the second open end for sealing at least one battery within said cavity. The releasable seal can be adhesive tape or a hook and loop attachment.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A method of manufacturing a fire suppressing packaging comprising:
forming a packaging sheet by securing a first sidewall to a second sidewall defining a cavity therebetween,
inserting an admixture of hydrated super absorbent polymer into said cavity;
constructing and arranging a container having said packaging sheet secured to said container;
wherein an item placed within said container that is breached by fire will rupture the packaging sheet allowing the admixture to flow onto the item to extinguish the fire.

2. The method of manufacturing a fire suppressing receptacle according to claim 1 wherein said admixture is non-conductive.

3. The method of manufacturing a fire suppressing receptacle according to claim 1 wherein said admixture is formed from a ratio of about 4 grams of super absorbent polymer hydrated with about 0.1 gallons of water.

4. The method of manufacturing a fire suppressing receptacle according to claim 1 wherein said plastic is selected from the group consisting of low density polypropylene, polyurethane, or polyisoprene.

5. The method of manufacturing a fire suppressing receptacle according to claim 1 wherein said super absorbent polymer is hydrated at a level to suppress airborne organic compounds and airborne metals from an overheated battery.

6. The method of manufacturing a fire suppressing receptacle according to claim 1 wherein said super absorbent polymer is an admixture of polyacrylamides/potassium acrylate.

7. The method of manufacturing a fire suppressing receptacle according to claim 1 wherein said super absorbent polymer is FireIce®.

8. The method of manufacturing a fire suppressing receptacle according to claim 1 including a mesh constructed and arranged to contain explosions is juxtapositioned along one of said sidewalls.

9. A method of manufacturing a fire suppressing receptacle for lithium batteries comprising:
forming a first rectangular shaped sidewall from flexible plastic, said first sidewall having a first longitudinal side edge spaced apart from a second longitudinal side edge extending between said first and second end edges;
forming a second rectangular shaped sidewall from flexible plastic, said second sidewall forming a mirror image of said first sidewall;
securing at least two side edges of said first and second shaped sidewall together forming a first cavity;
inserting an admixture of hydrated super absorbent polymer into said first cavity and sealing said first cavity;
securing at least a portion of each side edge together forming a second cavity;
wherein a lithium battery is insertable into the second cavity whereby a lithium battery breach will rupture the sidewall forming said second cavity allowing the admixture to flow to the lithium battery breach.

10. The method of manufacturing a fire suppressing receptacle for lithium batteries according to claim 9 including a releasable seal placed in the second open end for sealing at least one battery within said cavity.

11. The method of manufacturing a fire suppressing receptacle for lithium batteries according to claim 10 wherein said releasable seal is adhesive tape.

12. The method of manufacturing a fire suppressing receptacle for lithium batteries according to claim 10 wherein said releasable seal is a hook and loop attachment.

13. The method of manufacturing a fire suppressing receptacle for lithium batteries according to claim 9 wherein said admixture is non-conductive.

14. The method of manufacturing a fire suppressing receptacle for lithium batteries according to claim 9 wherein said admixture is formed from a ratio of about 4 grams of super absorbent polymer hydrated with about 0.1 gallons of water.

15. The method of manufacturing a fire suppressing receptacle for lithium batteries according to claim 9 wherein said extruded plastic is selected from the group consisting of low density polypropylene, polyurethane, or polyisoprene.

16. The method of manufacturing a fire suppressing receptacle for lithium batteries according to claim 9 wherein said super absorbent polymer is hydrated at a level to suppress airborne organic compounds and airborne metals from an overheated battery.

17. The method of manufacturing a fire suppressing receptacle for lithium batteries according to claim 9 wherein said super absorbent polymer is an admixture of polyacrylamides/potassium acrylate.

18. The method of manufacturing a fire suppressing receptacle for lithium batteries according to claim 17 wherein said super absorbent polymer is FireIce®.

19. The method of manufacturing a fire suppressing receptacle for lithium batteries according to claim 9 including a mesh constructed and arranged to contain battery explosions is juxtapositioned along one of said sidewalls.

20. A fire suppressing receptacle for lithium batteries comprising:
a receptacle forming a cavity sized for receipt of at least one lithium battery; and
an admixture of hydrated super absorbent polymer secured to said cavity;
wherein overheating of a lithium battery placed within said cavity will breach at least one sidewall releasing said admixture to suppress the overheated lithium battery.

21. The fire suppressing receptacle for lithium batteries according to claim 20 wherein said receptacle is formed from a first sidewall defined by a flexible sheet of plastic having a first and second end edges and first and second longitudinal side edges secured to a second sidewall having a mirror image of the first sidewall forming a space therebetween for receipt of said admixture.

22. The fire suppressing receptacle for lithium batteries according to claim 20 including a means for sealing said cavity.

23. The fire suppressing receptacle for lithium batteries according to claim 20 wherein said means for sealing means is a hook and loop attachment.

24. The fire suppressing receptacle for lithium batteries according to claim 23 wherein said means for sealing means is adhesive.

25. The fire suppressing receptacle for lithium batteries according to claim 20 wherein said admixture is potassium based and non-conductive when hydrated.

26. The fire suppressing receptacle for lithium batteries according to claim 20 wherein said admixture is a ratio of about 4 grams of said super absorbent polymer hydrated with about 0.1 gallons of water to suppress a lithium battery fire within the cavity.

27. The fire suppressing receptacle for lithium batteries according to claim 20 wherein said receptacle is formed from a material selected from the group consisting of low density polypropylene, polyurethane, or polyisoprene.

28. The fire suppressing receptacle for lithium batteries according to claim 20 including a mesh constructed and arranged to suppress a battery explosion with said cavity.

29. The fire suppressing receptacle for lithium batteries according to claim 20 wherein said super absorbent polymer is hydrated at a level to suppress airborne organic compounds and airborne metals from an overheated battery.

30. The fire suppressing receptacle for lithium batteries according to claim 20 wherein said super absorbent polymer is an admixture of polyacrylamides/potassium acrylate.

31. The fire suppressing receptacle for lithium batteries according to claim 20 wherein said super absorbent polymer is FireIce®.

32. The fire suppressing receptacle for lithium batteries according to claim 20 wherein said mesh is selected from the group consisting of steel wire, Kevlar, carbon fiber, or basalt.
